(19) United States
(12) Patent Application Publication
(10) Pub. No.: US 2009/0227129 A1
(43) Pub. Date: Sep. 10, 2009

(54) Electrical connector having grounding bridge

(75) Inventors: Yu-Hua Mao, Kunshan (CN); Zhi-Hong Fang, Kunshan (CN); Xue-Qing Zhang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/381,053

(22) Filed: Mar. 5, 2009

(30) Foreign Application Priority Data
Mar. 5, 2008 (CN) 200820032483.3

(51) Int. Cl. H01R 13/648; H01R 24/00

(52) U.S. Cl. 439/108; 439/607.58; 439/629

(57) ABSTRACT

An electrical connector includes an insulative housing (1) which comprise a pair of side walls (121) and a pair of end walls (122) linking with two ends of the side wall, a plurality of terminals (2) retained in the side wall and a pair of grounding bridges (3) received in the end wall. Each of the grounding bridge comprise a contacting part (31) engaging with a mating connector, a grounding part (32) and a conducting part (33) mechanically connecting with the contacting part and grounding part. And the conductive part (33) has a larger resistance compared with the contacting part and the grounding part. Therefore, the power current transmitting through the guiding bridge (3) can be lower.

### BACKGROUND OF THE INVENTION

1. Field of the Invention

The present invention relates to an electrical connector, especially to an electrical connector with grounding bridge.

2. Description of the Related Art

U.S. Pat. No. 6,663,402 issued on Dec. 16, 2003, discloses an electrical connector including an insulative housing, a plurality of terminals retained in the insulative housing, a pair of grounding bridges attached at the guiding columns at two ends of the insulative housing, and a metallic shell covers an outside of the insulative housing. Each of the guiding bridges has a body portion mechanically and electrically connecting with the metallic shell for discharging the static electricity of the mating connector by grounding, an elastic arm extending upwardly from the body portion. The elastic arm is closer to the mating connector than the terminals for earlier engaging with the mating connector electrically.

However, the grounding bridge is made of a metallic plate such as familiar iron, copper sheet, etc. When the electrical connector and the mating connector engage with each other, the static power current of the mating connector transmitting is likely over the endurable limit of the electrical connector when the resistance of the grounding bridge is not enough big, so it could damage the electrical connector system.

Therefore, an improved electrical connector is desired to overcome the disadvantages of the related arts.

### SUMMARY OF THE INVENTION

An object of the present invention is to provide an electrical connector with grounding bridge for discharging static thereof.

In order to achieve above-mentioned object, an electrical connector in accordance with a preferred embodiment of the present invention includes an electrical connector includes an insulative housing which comprise a pair of side walls and a pair of end walls linking with two ends of the side wall, a plurality of terminals retained in the side wall and a pair of grounding bridges received in the end wall. Each of the grounding bridge comprise a contacting part engaging with a mating connector, a grounding part and a conducting part mechanically connecting with the contacting part and grounding part. And the conductive part has a larger resistance compared with the contacting part and the grounding part. Therefore, the power current transmitting through the guiding bridge can be lower.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the preferred embodiment of the present invention;

FIG. 2 is an exploded perspective view of the electrical connector of FIG. 1;

FIG. 3 is a partly cross-section view of the electrical connector taken along line 3-3 of FIG. 1.

FIG. 4 is a perspective view of an electrical connector in accordance with the other embodiment of the present invention and without the conductive part thereof.

FIG. 5 is a sketch view of the grounding bridge of the electrical connector of FIG. 4.

### DETAILED DESCRIPTION OF THE INVENTION

Reference will now be made to the drawing figures to describe the preferred embodiment of the present invention in detail.

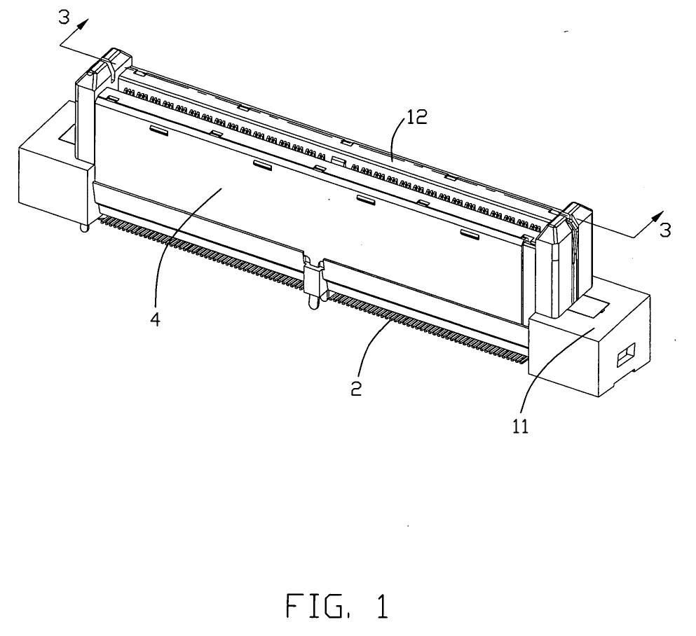

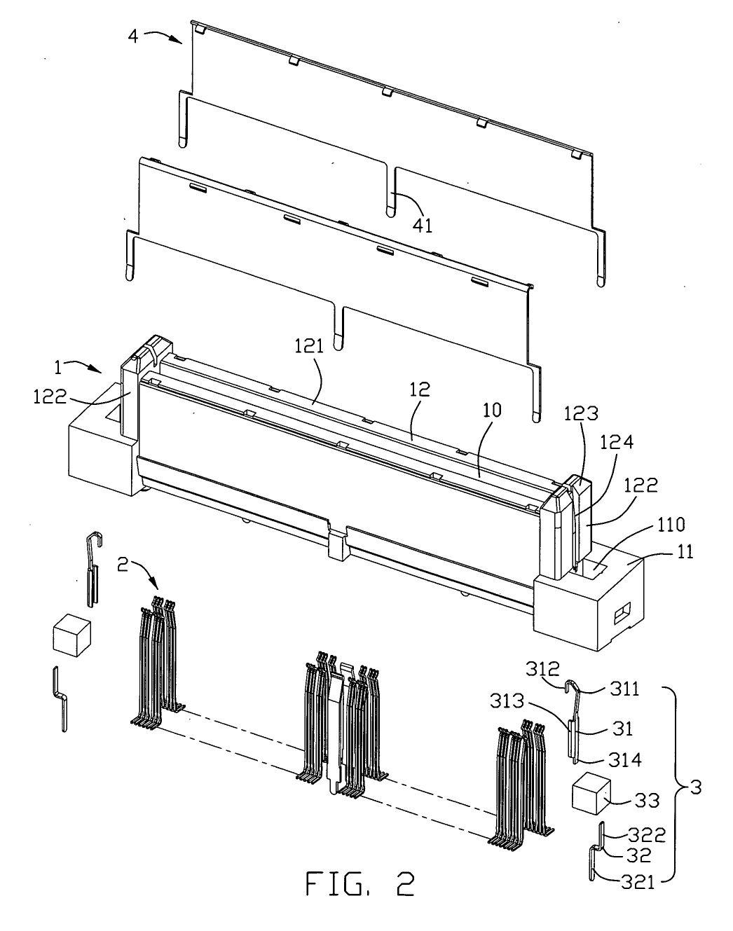

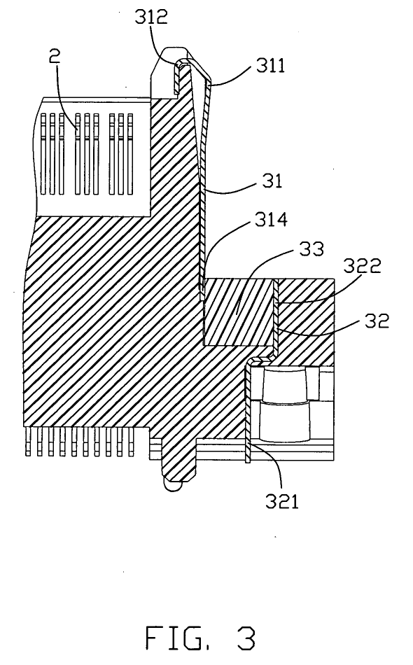

Referring to FIG. 1 to FIG. 3, an electrical connector 100 in accordance with the present invention includes an insulative housing 1, a plurality of terminals 2 retained in the insulative housing, a pair of grounding bridges 3 received in the insulative housing, and a pair of metallic shells 4 covering the insulative housing.

The insulative housing 1 is provided with a base portion 11 and a mating portion 12 upwardly extending from the base portion for mating with the mating connector. The base portion 11 is mounted on a PCB (not shown). The mating portion 12 includes a pair of longitudinal side walls 121 and a pair of end walls 122 integrally linking with two ends of the side walls, thereby forming a mating room 10 for receiving the mating connector. The end wall 122 defines a guiding portion 123 at the tip thereof for guiding the connector to mate with the mating connector. Each of the side walls 121 includes a plurality of passageways for retaining and receiving the terminals 2.

Each of the end walls defines a groove 124 extending along a mating direction and running through the outside face of guiding portion 123. The two ends of the base portion each defines a hole 110 communicating with the groove 124. The grounding bridge 3 includes three separately parts, a contacting part 31, a grounding part 32 and a conducting part 33. The contacting part 31 is received in the groove 124 and has retaining portion 313 bending inwardly and retained with the housing, a bottom end 314 protruding downward into the hole 110 and a contacting portion 311 extending to the top of the guiding portion 123 for firstly engaging with the mating connector. The contacting part 31 hooks the tip of the guiding portion 123 with a hooking portion 312 adjacent the contacting portion 311. The grounding parts 32 are embedded in the two ends of the base portions and each grounding part 32 includes a soldering portion 321 extending out of the housing to connect with a grounding trace of a PCB or the shell 4 and a touching portion 322 protruding into the hole 110. The conductive parts 33 of square shape are received in the hole 110 and each conductive part defines a pair of opposite contacting surfaces for contact with the bottom end 314 of the contacting part 31 and the touching portion 322 of the grounding part 32, thereby forming a ground trace electrically connecting with the grounding trace of a PCB.

The contacting part 31 and the grounding part 32 are made of conductive metal sheet, such as brass, nickel-copper, bronze, iron, stainless steel sheet and so on, while the conductive part 33 is made of such metal material, as electric plastic, electric foam and so on, with a larger resistance compared with the contacting part and the grounding part. Therefore, the power current transmitting through the guiding bridge 3 can be lower.

The metallic shells 4 cover on the side walls 121 for preventing the electrical connector from EMI (Electro Magnetic Interference) with a plurality of retaining tails 41 inserted in the insulative housing at the end thereof.

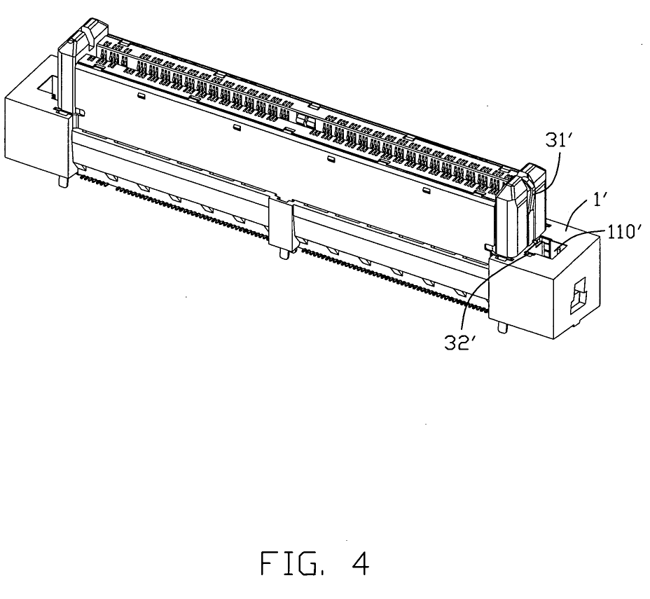

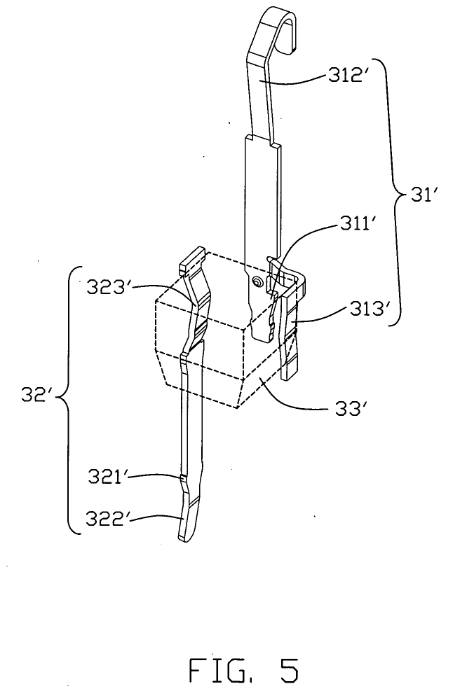

Referring FIG. 4 and FIG. 5, an electrical connector of another embodiment of the present invention is shown, which is similar to that of aforementioned connector except a described grounding bridge 3′.

The contacting part 31′ of the grounding bridge 3′ is provided with a retaining portion 311′ at the bottom end thereof for retained in the housing, a contacting portion 312′ extending upwards to the top of the end wall from the retaining portion, a first touching portion 313′ extending perpendicularly to the contacting portion and protruding into one side of the hole 110′ for engaging with the conductive part 33′. The grounding part 32′ includes a retaining portion 321′ at the middle thereof retained in the housing, a soldering portion 322′ extending out of the housing to connect with a grounding trace of a PCB or the shell and a second touching portion 323′ extending upwards from the retaining portion 321′ and protruding into another side opposite said one side of the hole 110′. The first touching portion 313′ and the second touching portion 323′ touch the conductive parts 33′, thereby forming a ground trace electrically connecting with the grounding trace of a PCB. As the aforementioned connector, the contacting part 31′ and the grounding part 32′ has a larger resistance compared with the contacting part and the grounding part. Therefore, the power current transmitting through the guiding bridge 3′ can be lower. The contacting part 31′ and the grounding part 32′ touching at opposite surface of the conductive part 33′ benefit a better electrical performance.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector comprising:
an insulative housing comprising a pair of side wall and a pair of end walls linking with two ends of the side walls;
a plurality of terminals retained in the side wall; and
a pair of grounding bridges received in the end wall, each of the grounding bridge comprising a contacting part engaging with a mating connector, a grounding part and a conducting part mechanically connecting with the contacting part and grounding part;
wherein the conductive part has a larger resistance compared with the contacting part and the grounding part.

2. The electrical connector as described in claim 1, wherein the contacting part and the grounding part are retained between of the conducting part and the insulative housing.

3. The electrical connector as described in claim 2, wherein the end wall comprises a groove running through the outside face of the end wall for receiving the contacting part.

4. The electrical connector as described in claim 1, wherein the insulative housing comprises a pair of holes communicating with the groove at both ends thereof for receiving the conductive parts.

5. The electrical connector as described in claim 4, wherein the grounding part is embedded in the insulative housing and comprise a touching portion engaging with one side of the conductive part and a soldering portion connecting with a grounding trace.

6. The electrical connector as described in claim 5, wherein the contacting part comprises a retaining portion retained with the housing, a contacting portion extending towards the top of the end wall, a hooking portion adjacent the contacting portion for hooking the top of the end wall, and a bottom end extending from the retaining portion for engaging with another side of the conductive part.

7. The electrical connector as described in claim 1, wherein the insulative housing comprises a pair of holes at both ends thereof to receive the conductive part.

8. The electrical connector as described in claim 7, wherein the contacting part comprise a first touching portion protruding into one side of the hole, the grounding portion comprise a second touching portion protruding into another side opposite to said one side of the hole, and the first and second touching portion engage with two opposite sides of the conductive part separately.

9. The electrical connector as described in claim 7, wherein the contacting part has a retaining portion retained in the insulative housing, a contacting portion extending towards the top of the end wall, a hooking portion adjacent the contacting portion for hooking the top of the end wall, and the first touching portion extends perpendicularity to the contacting portion.

10. The electrical connector as described in claim 8, wherein the grounding portion comprises a retaining portion retained in the insulative housing, a soldering portion connecting with a grounding trace and the second touching portion extending upwards from the retaining portion.

11. The electrical connector as described in claim 4, wherein the conducting part is of a cuboid shape and made of electric plastic, and comprises a pair of opposite contacting surface separately connecting with the contacting part and the grounding part.

12. The electrical connector as described in claim 2, wherein the conducting part joints with the contacting part and the grounding part.

13. The electrical connector as described in claim 1, wherein the side wall and the end wall surround a mating room for receiving the mating connector.

14. An electrical connector assembly for use with a complementary connector, comprising:
an insulative housing defining a mating port;
a plurality of terminals disposed in the housing with contacting sections exposed in the mating port and soldering sections for mounting to a printed circuit board; and
a grounding bridge located at an end of the housing to having two ends respectively engaged with the complementary connector and the printed circuit board to create a grounding path therebetween; wherein
said grounding bridge includes two sections having different resistance characters with each other, of which a larger one belonging to the section which is spaced from the complementary connector.

15. The electrical connector assembly as claimed in claim 14, wherein said two sections are discrete from each other while being in an intimate contact manner.

16. The electrical connector assembly as claimed in claim 15, wherein said grounding bridge further includes another section for directly mounting to the printed circuit board with a resistance character smaller than the larger one.

17. The electrical connector assembly as claimed in claim 16, wherein the section having the larger resistance character, defines a lumpy configuration while the section of the smaller resistance character defines a thin plate configuration.

18. The electrical connector assembly as claimed in claim 17, wherein the section having the larger one resistance character is made of electric plastic or form while the section having the smaller resistance character is made of metallic.
